(19) United States
(12) Patent Application Publication
(10) Pub. No.: US 2026/0195908 A1
(43) Pub. Date: Jul. 9, 2026

(54) METHOD FOR ALIGNING THE FACE OF A PERSON IN AN IMAGE

(71) Applicant: IDEMIA PUBLIC SECURITY FRANCE, Courbevoie (FR)

(72) Inventors: François D'YVOIRE, Courbevoie (FR); Damien MONET, Courbevoie (FR)

(73) Assignee: IDEMIA PUBLIC SECURITY FRANCE, Courbevoie (FR)

(21) Appl. No.: 19/423,140

(22) Filed: Dec. 17, 2025

(30) Foreign Application Priority Data
Jan. 3, 2025 (FR) FR2500028

(51) Int. Cl. G06T 7/33; G06T 7/68; G06T 7/73; G06V 10/24; G06V 40/16

(52) U.S. Cl. CPC G06T 7/33; G06T 7/68; G06T 7/73; G06V 10/247; G06V 40/168; G06T 2207/20084; G06T 2207/30201

(57) ABSTRACT

A method implemented by a data-processing device for aligning a face of an individual in an image. The method includes detecting, in an image of the face of an individual, positions of a left eye, of a right eye, of a midpoint between the right eye and left eye, and of a midpoint of a mouth, applying a first geometric transformation so that the positions of the midpoint between the left eye and right eye and of the midpoint of the mouth coincide with reference points, and applying a second geometric transformation so that the position of a closest eye in a depth of the image coincides with the position of a vertical reference line.

### TECHNICAL FIELD

The present invention relates to a method, implemented by a data-processing device, for aligning the face of an individual in an image.

### TECHNICAL BACKGROUND

It is common to use protocols based on comparison of certain biometric features of the face of individuals to identify (1:N) and/or authenticate (1:1) them, in order to allow them to access remote services, to permit them access to information stored in a communal or personal database, to check an identity (for example when crossing a border), or even to permit them access to a restricted area.

Irrespectively of whether it is carried out for authentication or identification purposes, the comparison of biometric features is generally not based on raw data, i.e. data exactly as recorded, but on derived biometric data resulting from application of a type of algorithmic processing called encoding. According to section 3.21 of ISO/IEC standard 19794-1: 2011 Information technology—Biometric data interchange formats—Part 1: Framework, the derived biometric data form a “biometric template” or “biometric model” that differs from the raw data used to obtain it, and that may be compared with other biometric templates.

When the biometric identification or authentication is based on facial recognition, the acquired biometric data take the form of one or more images or photographs of the face of the person or persons to be identified or authenticated.

The ability of a given encoding process to generate a reliable biometric template from the image of a face depends on the pose of the face with respect to the device acquiring the one or more images thereof, and on its facial expression. In general, the encoding process requires the face to have an alignment suitable for generating a biometric template. However, when their image is acquired, the faces of people rarely have, with respect to the acquiring device, an (in particular straight-on and centered) pose allowing images that may be used directly to generate biometric templates to be obtained. For this reason, encoding processes comprise a prior aligning operation. Thus, the encoding processes used to recognize a face in an image are based on three successive operations:
detection of the face, alignment of the face, and representation of the face in the form of a biometric template, typically a vector of the features of the face. A review of encoding methods used for facial recognition comprising these three operations has been provided by Du, H., et al. (2022). The elements of end-to-end deep face recognition: A survey of recent advances. ACM Computing Surveys (CSUR), 54(10s), 1-42.

Most aligning methods employ a geometric transformation of the face to make certain landmarks or keypoints on the face (such as the eyes, nose and/or mouth) correspond to reference points of a canonical shape or of a prototype. The geometric transformation may be a regression applied to the position of the reference points or to a heatmap of the face, or even to a model of a three-dimensional shape of the face based on the two-dimensional shape of the face shown in the image.

EP 2 031 544 A1 SONY CORP [JP] 04.03.2009 describes a method for processing an image of a face comprising a step of correcting the position of keypoints of the face, and in particular of correcting the yaw and roll angles of the face on the basis of values estimated in a prior step of estimating the pose of the face.

Chai, X., et al. (2003). Pose normalization for robust face recognition based on statistical affine transformation. In Fourth International Conference on Information, Communications and Signal Processing, 2003 and the Fourth Pacific Rim Conference on Multimedia. Proceedings of the 2003 Joint (Vol. 3, pp. 1413-1417). IEEE describes an aligning method in which the image of the face is divided into three rectangular regions the geometric parameters of which are then modified by applying an affine transformation to convert the specific pose of the face in the image into a straight-on pose.

Tuzel, O., et al. (2016). Robust face alignment using a mixture of invariant experts. In Computer Vision—ECCV 2016: 14th European Conference, Amsterdam, The Netherlands, Oct. 11-14, 2016, Proceedings, Part V 14 (pp. 825-841). Springer International Publishing describes, for example, an aligning method comprising alternating multiple affine transformations and multiple regression functions. The parameters of the affine transformations are optimized on small sets of training images in order to convert landmark points estimated on faces by the regression functions into reference points of a face prototype. The regression functions are gradient-descent regression functions specialized in the estimation of reference points for particular facial poses and expressions.

### SUMMARY OF THE INVENTION

The objective of current methods for aligning a face within an image is to determine the position of landmarks or keypoints of the face (such as the eyes, nose and/or mouth) and then perform a transformation of the face in order to make these keypoints correspond to the reference points of a canonical shape or of a face prototype. However, it has been observed that the performance of a given encoding algorithm, in terms of the accuracy and reliability of the biometric templates that it generates from an image, decreases if the position of the keypoints in the image varies, even when a match between these keypoints and the reference points of a prototype has been obtained beforehand. In particular, the ability of such an encoding algorithm to accurately compare, during its training, the various poses of a face are negatively affected, and its performance during a subsequent encoding operation, after its training, may deteriorate.

A first aspect of the invention relates to a method, implemented by a data-processing device, for aligning the face of an individual in an image, the method comprising the following steps:
(a) detecting, in an image of the face of an individual, the positions of a left eye, of a right eye, of a midpoint between the right eye and left eye, and of a midpoint of the mouth;
(b) applying a first geometric transformation so that the positions of the midpoint between the left eye and right eye and of the midpoint of the mouth coincide with reference points;
(c) applying a second geometric transformation so that the position of the closest eye in the depth of the image coincides with the position of a vertical reference line.

In some embodiments, the first geometric transformation is an affine transformation.

In some embodiments, the second geometric transformation is a translation the norm of which is proportional to the yaw angle.

In some embodiments, the parameters of the first geometric transformation and/or of the second geometric transformation are adjusted in a prior learning step using a regression method applied to a set of training images comprising images of faces with various poses.

In some embodiments, the vertical reference line is located at a distance from a center line of the image of between zero and one third of the width of the image.

In some embodiments, the nearest eye may be determined based on an estimate of the yaw angle γ or on a comparison of the position of the nose with the position of a line between a midpoint of the mouth and a midpoint between the left eye and the right eye.

A second aspect of the invention relates to a data-processing device comprising means for implementing a method according to any one of the embodiments of the first aspect of the invention.

A third aspect of the invention relates to a computer program comprising instructions that, when the program is executed by a data-processing device, cause the latter to implement a method according to any one of the embodiments of the first aspect of the invention.

A fourth aspect of the invention relates to a method for encoding an image of a face of an individual, the method comprising the following steps:
acquiring an image of the face of an individual;
aligning the face of the individual using an aligning method according to any one of the embodiments of the first aspect of the invention;
encoding the image of the aligned face into a biometric template using an encoding scheme.

A fifth aspect of the invention relates to a terminal enabling identification through facial recognition, comprising:
a device for acquiring an image of the face of an individual;
a data-processing device according to the second aspect of the invention.

### BRIEF DESCRIPTION OF THE DRAWINGS

FIG. 1 is a schematic representation of an access control zone comprising a biometric identification terminal and a system of gates.

FIG. 2 is a schematic representation of one example of a biometric identification terminal.

FIG. 3 is a schematic representation of the yaw, pitch and roll angles of a human head.

FIG. 4 is a schematic representation of a face with various poses and in particular various yaw angles.

FIG. 5 is a schematic representation of estimated keypoints on a face seen straight-on.

FIG. 6 is a schematic representation of estimated keypoints on a face seen in profile.

FIG. 7 is a flowchart of an aligning method according to the first aspect of the invention.

FIG. 8 is a schematic representation of the result of a first geometric transformation applied to a face according to one embodiment of the invention.

FIG. 9 is a schematic representation of the result of a second geometric transformation applied to a face according to one embodiment of the invention.

### DETAILED DESCRIPTION OF THE EMBODIMENTS

In the present disclosure, embodiments are described in the general context of one or more pieces of hardware or devices capable of executing preloaded instructions such as, for example, computer-executable instructions for executing program modules. The program modules may include one or more routines, programs, objects, variables, commands, scripts, functions, applications, components and/or data structures able to execute particular tasks or implement particular types of abstract data.

Some embodiments may also be implemented in distributed computing environments where tasks are executed by remote data-processing devices that are connected by a communication network. In a distributed computing environment, the program modules may reside on local and/or remote computer storage media, including memory storage devices.

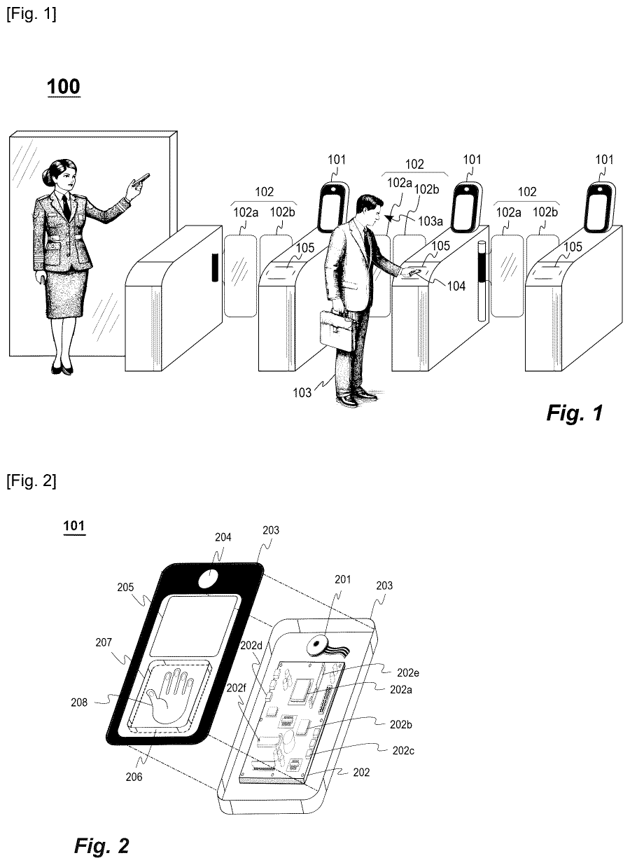

With reference to FIG. 1, in one purely illustrative example, an access control zone 100 where access to a site, event or territory is controlled may comprise a terminal 101 enabling biometric identification through facial recognition and a system 102 of access gates 102a, 102b that are able to be opened or closed to an individual 103 depending on the success or failure of a biometric identification of said individual 103 by said biometric identification system 101.

When an individual 101 wishes to access the site, event or territory, they must first identify themselves to the biometric identification terminal 101 by submitting an identification request to said terminal 101. In the example shown in FIG. 1, the request may be submitted through a mobile terminal 104, such as a smartphone, storing identity data, such as an identifier, a passport and/or an electronic ticket. The biometric identification terminal 101 may then communicate with a contactless reader 105 configured to read a non-transient memory or a secure element of the mobile terminal 104 in order to access the identity data and/or the electronic ticket stored therein. In another equivalent example, the request may be submitted by placing a physical ticket or a chip card on the reader 105 of the biometric identification terminal 101. The reader 105 may be a contactless reader configured to read a non-transient memory or a secure element contained in the chip card or the physical ticket, and/or an optical reader configured to read a code, such as a QR code, displayed on the ticket.

Once the request has been submitted, the biometric identification terminal 101 reads the content of the secure element of the mobile terminal 104 and then acquires a test biometric feature of the individual 103 using a suitable acquiring device. In the present case, since the biometric identification terminal 101 is a terminal enabling biometric identification through facial recognition, the acquiring device is a video camera or a still camera and the test feature is an image of the face 103a of the individual 103 (also called the “face print”).

Once the face print has been acquired by the acquiring device, the biometric identification terminal 101 identifies the individual 103 on the basis of the print. If the individual 103 is identified, they are permitted to access the site, event or territory. To this end, the biometric identification terminal 101 sends a signal commanding the gates 102a, 102b to open to the system 102 of gates 102a, 102b. Otherwise, the user 103 is not identified and is denied access. The gates 102a, 102b of the system 102 of gates 102a, 102b remain closed. The biometric identification terminal 101 may notify the user 103 of the success or failure of the identification using a light signal, a sound signal, a message, or a combination thereof.

The biometric identification terminal 101 as described above may be used for other purposes, such as permitting access to one or more remote services, permitting access to information stored in a communal or personal database, checking the identity of one or more persons, retrieving login credentials, or even retrieving one or more addresses of wallets for digital currency such as a cryptocurrency.

According to one example, with reference to FIG. 2, the biometric identification terminal 101 comprises a physical image-acquiring module 201, a physical data-processing module 202 and a protective housing 203.

The physical image-acquiring module 201 takes the form of a camera configured to acquire the image of a face. The protective housing 203 comprises a transparent or semi-transparent window 204 with a view to allowing the image to be acquired by the image-acquiring module 201, and an interactive or display screen 205.

The physical image-acquiring module 201 transmits the acquired data to the physical data-processing module 202 by means of a connector (not shown). The physical data-processing module 202 comprises means for carrying out a biometric identification. It is responsible for automatically executing sequences of arithmetic or logic operations in order to perform tasks or actions. This module, commonly called a computer, may comprise one or more central processing units (CPUs) 202a and/or one or more graphics processing units (GPUs) 202b, a physical remote-communication module 202c, one or more physical input/output modules 202d for exchanging data with external devices, a transient storage medium 202e such as a random-access memory (RAM), a non-transient recording medium 202f and communication busses (not shown) for transferring data between the internal components of the data-processing module 202.

The physical data-processing module 202 is used to execute one or more program modules comprising instructions that, when the program module or modules are executed, cause the data-processing module 202 to carry out a biometric identification. The program module or modules may be written in any, compiled or interpreted, programming language. They may form part of a software solution, i.e. of a collection of executable instructions, of codes, of scripts or the like and/or of databases.

The biometric identification terminal 101 as described above may be used for other purposes, such as permitting access to one or more remote services, permitting access to information stored in a communal or personal database, checking the identity of one or more persons, retrieving login credentials, or even retrieving one or more addresses of wallets for digital currency such as a cryptocurrency.

The biometric identification terminal 101 is configured to generate, according to an encoding scheme, a test biometric template from the test face print acquired by the image-acquiring device 201, 206 and then to compare said template with one or more reference biometric templates stored in a database. If there is a match between the test biometric template and a reference biometric template, the individual 103 is identified and is permitted to access the site, event or territory. Otherwise, the user 103 is not identified and is denied access.

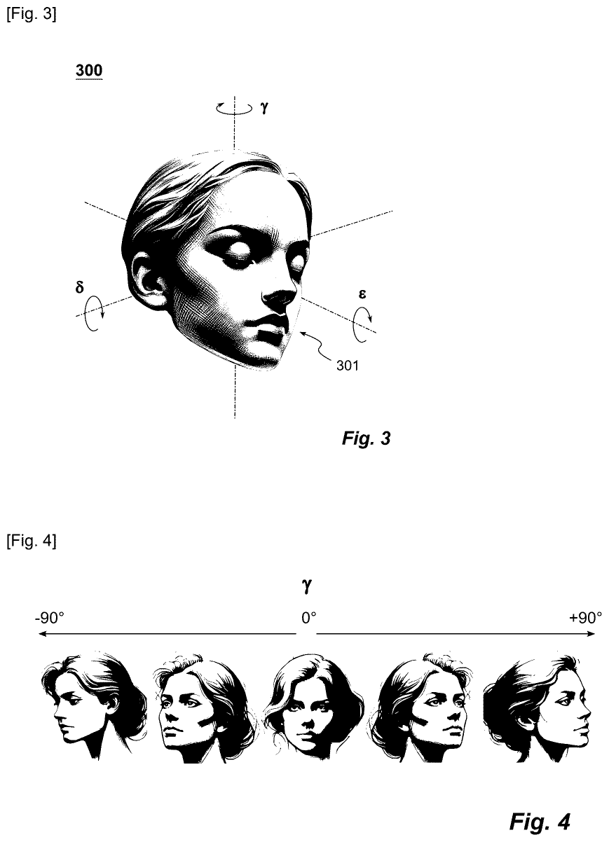

The ability of a given encoding process to generate a reliable biometric template from the image of a face depends on the pose of the face and its facial expression. With reference to FIG. 3, the pose of the face 301 of an individual is related to the pose of their head 300. This pose may be characterized by three angles: the yaw angle γ, the pitch angle δ and the roll angle ε.

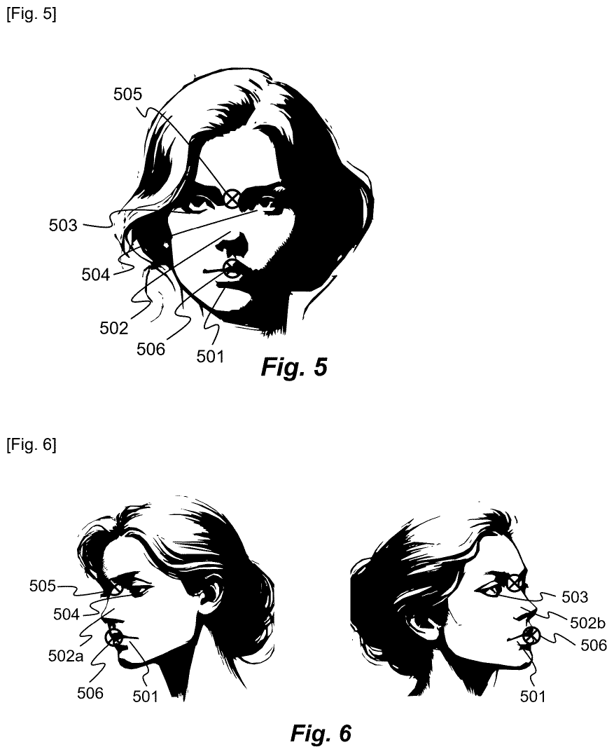

In practice, the yaw angle γ mainly determines the number and the degree of completeness of the facial keypoints (such as the eyes, the nose and the mouth) visible in an image. FIG. 4 shows a face in various poses, in particular poses with various yaw angles γ, illustrating this dependence. With reference to FIG. 4 & FIG. 5, when the face is oriented straight-on (γ=0°), the mouth 501, the nose 502, the left eye 503 and the right eye 504 are visible in their entirety. In FIG. 4, a midpoint 505 between the left eye 503 and right eye 504, corresponding, for example, to half an interpupillary distance measured between these two eyes, and a midpoint 506 of the mouth 501 have been represented by symbols in the form of circles with superimposed X's. With reference to FIG. 4 & FIG. 6, when the face is oriented to have a right profile γ~(−80°;−90°) or left profile γ~(80°; 90°), the right half 501 a and left half 501b of the mouth 501, the right nostril 502a and left nostril 502b of the nose 502 and the right eye 504 and left eye 503 are mainly visible, respectively. In these extreme poses, therefore, only one of the eyes 503, 504 is entirely visible, and the nose 502 and mouth 501 are only partially visible. In FIG. 6, a midpoint 505 between the left eye 503 and right eye 504 and a midpoint 506 of the mouth 501 have been represented by symbols in the form of circles with superimposed X's. A point on the outer edge of the mouth 501 is considered to be representative of a midpoint 506 of the mouth 501, and the outer edge of the nose 501 is considered to be representative of a midpoint 505 between the left eye 503 and right eye 504. With reference to FIG. 4, poses intermediate between the profile view (γ~(±80°; ±90°)) and the straight-on view (γ=0°), the visibility of the facial keypoints varies continuously.

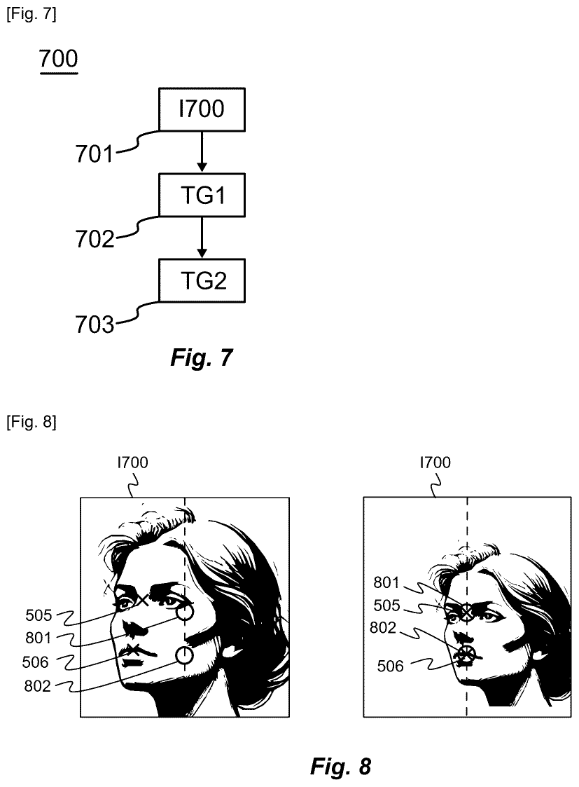

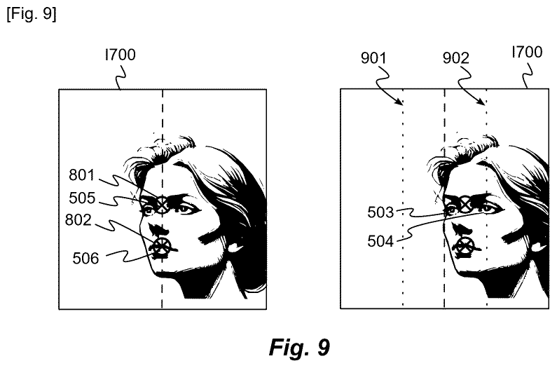

According to a first aspect of the invention, with reference to FIG. 7, FIG. 8 and FIG. 9, a method 700, implemented by a data-processing device 202, for aligning a face 103a, 301 of an individual 103 in an image I700 is provided, the method 700 comprising the following steps:
(a) detecting 701, in an image I700 of the face 103a, 301 of an individual 103, the positions of a left eye 503, of a right eye 504, of a midpoint 505 between the right eye 504 and left eye 503, and of a midpoint 506 of the mouth 501;
(b) applying 702 a first geometric transformation TG1 so that the positions of the midpoint 505 between the left eye 503 and right eye 504 and of the midpoint 506 of the mouth 501 coincide with reference points 801, 802;
(c) applying 703 a second geometric transformation TG2 so that the position of the closest eye 503, 504 in the depth of the image I700 coincides with the position of a vertical reference line 901, 902.

In step 701, the positions of a left eye 503, of a right eye 504, of a midpoint 505 between the right eye 504 and left eye 503, and a midpoint 506 of the mouth 501 may be detected using any suitable method. Examples of methods are described in Du, H., et al. (2022). The elements of end-to-end deep face recognition: A survey of recent advances. ACM Computing Surveys (CSUR), 54(10s), 1-42.

In step 702, with reference to FIG. 8, the objective of application of the first geometric transformation TG1 is to make the positions of the midpoint 505 between the left eye 503 and right eye 504 coincide with the midpoint 506 of the mouth 501 and these midpoints coincide with reference points 801, 802. In FIG. 8, the reference points have been represented by circles; and the midpoint 505 between the left eye 503 and left right 504 and the midpoint 506 of the mouth 501 have been represented by crosses.

The reference points 801, 802 are predefined points and generally correspond to particular points of a canonical shape or of a face prototype 803 with which an encoder is configured to generate a biometric template from a face print calibrated with the canonical shape or prototype 803. By way of example, the reference points 801, 802 may be the midpoint of the mouth 804 and a midpoint between the eyes 805,806 of the face prototype 803. Matching, by virtue of the first geometric transformation TG1 applied to all the pixels of the image I700, the midpoint 505 between the left eye 503 and right eye 504 and the midpoint 506 of the mouth 501 of the face of the image I700 with these two reference points places the features of the face in positions within the image I700 allowing them to be processed by the encoder. In other words, the features of the face are in the positions “expected” by the encoder.

Preferably, the first geometric transformation TG1 is not implemented by an artificial neural network. It is preferably an affine transformation, i.e. a transformation that preserves the collinearity and the distance ratios between the points. For example, it may be a translation, a scaling (reduction or enlargement), a rotation, or a combination thereof.

In some embodiments, the first geometric transformation TG1 is an affine transformation.

By way of example, an affine transformation in a two-dimensional space may be represented by T=M. [x, y,1]^{T}, where T is the transformed vector, M is a 2×3 transformation matrix, and [x, y, 1]^{T} is an input vector. The matrix M is formed from a matrix A the dimension of which is 2×2 A and the linear-transformation parameters of which are [a₀₀, a₀₁; a₁₀, a₁₁], and from a translation vector B the dimension of which is 2×1 and the elements of which are [b₀₀, b₁₀]. The transformation T is the application of the matrix M to the input vector [x, y, 1]^{T} to obtain a transformed vector [a₀₀x+a₀₁y+b₀₀, a₁₀x+a₁₁y+b₁₀]^{T}. It is a combination of a linear transformation, such as a scaling and/or rotation, and a translation in a matrix formulation. The translation vector B may be null, i.e. there is no translation. The matrix M then reduces to matrix A.

The yaw angle, γ, may be estimated using a previously trained neural network, or by comparing the position of the tip of the nose to the straight line connecting the center of the eyes to the midpoint of the mouth.

The parameters of the affine transformation may be adjusted in a prior learning step using a regression method applied to a set of training images comprising images of faces with various poses. It is then a question, for each image, of determining the parameter values in order to minimize the discrepancy between reference points such as the reference points of a template and the midpoints of the mouth and eyes. The final parameter values are those that minimize the discrepancy for all the training images. The least-squares minimization method makes it possible, for example, to find the transformation (scale, rotation and translation) parameters that minimize the sum of the distances to the power of two between the source points and the corresponding transformed destination points.

In practice, during a facial recognition operation, whether the individual is static or in motion, their head is generally not inclined or else only slightly inclined—its roll angle ε is substantially zero. If it is, the first geometrical transformation may comprise a prior rotation operation. The rotation angle varies as a function of the roll angle ε of the head, which itself varies from one face to another; in particular, preferably, the rotation angle has a value that is the opposite of the value of the roll angle ε. When the first geometric transformation TG1 is an affine transformation, the rotation is, preferably, applied before the affine transformation is applied.

At the end of step 702, the midpoint 505 between the left eye 503 and right eye 504 and the midpoint 506 of the mouth 501 are aligned with the reference points 801, 802. In practice, the reference points 801, 802 are generally placed in the central region of the image, often on a center line 803 of the image I700. This arrangement causes an offset, which increases as the yaw angle γ gets further from 0°, between the actual position of the eyes 503, 504 and the position where the encoder requires the same eyes to be to be able to generate a biometric template from the image I700. In other words, at the end of step 702, the eyes are not placed where they must be for the encoder to be able to correctly “recognize” and process the features of the face to generate a biometric template.

In step 703, with reference to FIG. 9, a second geometric transformation TG2 is applied to align the closest eye 503, 504, i.e. the closest eye in the depth of the image I700, with a vertical reference line 901, 902. By “the closest eye in the depth”, what is meant is the eye, out of the left eye 503 and right eye 504, the position of which in a virtual direction perpendicular to the image is closest the plane of the image, or indeed, what is meant is the left eye 503 when the yaw angle γ is between 0°and 90°or the eye 504 when the yaw angle γ is between 0°and −90 °. If the eyes 503, 504 are equidistant from the plane of the image, in particular when the yaw angle γ is substantially equal to 0°, the closest eye may be either the left eye 503 or the right eye 504.

The closest eye in the depth of the image I700 may be determined using any suitable method. In some examples of embodiment, the nearest eye may be determined based on an estimate of the yaw angle γ or on a comparison of the position of the nose 502 with the position of a line between a midpoint 506 of the mouth 501 and a midpoint 505 between the left eye 503 and the right eye 504. It may also be determined using an image-processing algorithm and/or a stereographic acquiring device such as a stereographic camera allowing a depth map of the features of the face to be estimated.

As illustrated in FIG. 9, the vertical reference line 901, 902 may be different depending on whether the closest eye is the left eye 503 or the right eye 504. If the closest eye is the left eye 503, the vertical reference line is a vertical line 901 located in the left half 904 of the image I700. If the closest eye is the right eye 504, the vertical reference line is a vertical line 902 located in the right half 905 of the image I700. If either of the two eyes 503, 504 could be the closest, the vertical reference line may be either a vertical line 901 located in the left half 904 of the image I700 or a vertical line 902 located in the right half 905 of the image I700. In the example of FIG. 9, the closest eye is the right eye 504, which is then aligned with the vertical line 902 located in the right half 905 of the image I700.

The position of the vertical reference line 901, 902 in the image I700 is determined by the prerequisites of the encoder liable to be used to generate a biometric template from the image I700. In practice, in certain practical embodiments, the vertical reference line 901, 902 is located at a distance from a center line 903 of the image I700 of between zero and one third of the width of the image I700. The distance may be expressed in pixels or metric units whenever a conversion scale is available.

According to one practical example, the distance is substantially equal to half a reference interpupillary distance. The interpupillary distance may be an average interpupillary distance representative of a population of individuals. It may be 62 mm when the biological sex of the individuals is ignored. If the population of individuals the facial features of which are to be acquired may be characterized by their biological sex, the interpupillary distance may be selected to lie between 51 mm and 74.5 mm for females and between 53 mm and 77 mm for males.

The second geometric transformation TG2 is of any type suitable for placing the closest eye 503, 504 in the depth of the image I700 on the vertical reference line 901, 902. In some embodiments, the second geometric transformation TG2 is a translation the norm of which is proportional to the yaw angle γ. By way of example, returning to the previous example of the translation vector B of dimension 2×1, this vector may then be a non-null translation vector the value of the parameter B₁₀ of which is proportional to the yaw angle γ.

According to a second aspect of the invention, with reference to FIG. 2, provision is made for a physical module or device 202 for processing data comprising means for implementing a method 700 according to any of the embodiments of the first aspect of the invention. The physical module or device 202 for processing data may be an integral part of a biometric identification terminal 101 or it may be a remote element, such as a server, that communicates with the identification terminal 101 via a telecommunication network.

According to a third aspect of the invention, provision is made for a computer program comprising instructions that, when the program is executed by a physical module or device 202 for processing data, cause the latter to implement a method 700 according to any of the embodiments of the first aspect of the invention. The program may be written in any, compiled or interpreted, programming language. It may be part, in module form, of a software solution, i.e. of a collection of executable instructions, of codes, of scripts or the like and/or of databases of program modules. Whatever its form, it is preferably recorded on a non-transient recording medium 202f of the physical module or device 202 for processing data.

According to a fourth aspect of the invention, provision is made for a method for encoding an image I700 of a face 103a, 301 of an individual 103, the method comprising the following steps:
acquiring an Image I700 of the Face 103a, 301 of an Individual 103;
aligning the face 103a, 301 of the individual 103 using an aligning method 700 according to any of the embodiments of the first aspect of the invention;
encoding the image of the aligned face into a biometric template using an encoding scheme.

Any type of encoding scheme may be used to encode the aligned image of the face into a biometric template. Examples of encoding methods or schemes are described in Du, H., et al. (2022). The elements of end-to-end deep face recognition: A survey of recent advances. ACM Computing Surveys (CSUR), 54(10s), 1-42.

According to a fifth aspect of the invention, provision is made for a terminal 101 enabling identification through facial recognition, comprising:
a device 201 for acquiring an image I700 of the face of an individual 103;
a data-processing device 202 configured to execute an aligning method 700 according to any of the embodiments of the first aspect of the invention.

### REFERENCES

### Patent Literature

EP 2 031 544 A1 SONY CORP [JP] Apr. 3, 2009.

### Non-patent Literature

Chai, X., et al. (2003). Pose normalization for robust face recognition based on statistical affine transformation. In Fourth International Conference on Information, Communications and Signal Processing, 2003 and the Fourth Pacific Rim Conference on Multimedia. Proceedings of the 2003 Joint (Vol. 3, pp. 1413-1417). IEEE.
Tuzel, O., et al. (2016). Robust face alignment using a mixture of invariant experts. In Computer Vision—ECCV 2016: 14th European Conference, Amsterdam, The Netherlands, Oct. 11-14, 2016, Proceedings, Part V 14 (pp. 825-841). Springer International Publishing.
Du, H., et al. (2022). The elements of end-to-end deep face recognition: A survey of recent advances. ACM Computing Surveys (CSUR), 54(10s), 1-42.

1. A method implemented by a data-processing device, for aligning a face of an individual in an image the method comprising:
(a) detecting , in an image of the face of an individual, positions of a left eye, of a right eye, of a midpoint between the right eye and left eye, and of a midpoint of a mouth; and
(b) applying a first geometric transformation so that the positions of the midpoint between the left eye and right eye and of the midpoint of the mouth coincide with reference points a second geometric transformation so that the position of a closest eye in a depth of the image coincides with the position of a vertical reference line

2. The method according to claim 1, wherein the first geometric transformation is an affine transformation.

3. The method according to claim 1, wherein the second geometric transformation is a translation a norm of which is proportional to a yaw angle γ.

4. The method according to claim 1, wherein parameters of the first geometric transformation and/or of the second geometric transformation are adjusted in a prior learning step using a regression method applied to a set of training images comprising images of faces with various poses.

5. The method according to claim 1, wherein the vertical reference line is located at a distance from a center line of the image of between zero and one third of a width of the image.

6. The method according to claim 1, wherein a nearest eye is determined based on an estimate of a yaw angle γ or on a comparison of the position of a nose with the position of a line between a midpoint of the mouth and a midpoint between the left eye and the right eye.

7. A data-processing device comprising means for implementing the method according to any of claim 1.

8. A non-transitory computer-readable storage medium including computer executable instructions, wherein the instructions, when executed by a computer, cause the computer to implement the method according to claim 1.

9. A method for encoding an image of a face of an individual, the method comprising:
acquiring an image of the face of an individual;
aligning the face of the individual using the method as claimed in any claim 1; and
encoding the image of the aligned face into a biometric template using an encoding scheme.

10. A terminal enabling identification through facial recognition, comprising:
a device for acquiring an image of the face of an individual; and
the data-processing device according to claim 7.

11. The method according to claim 2, wherein the second geometric transformation is a translation a norm of which is proportional to a yaw angle γ.

12. The method according to claim 2, wherein parameters of the first geometric transformation and/or of the second geometric transformation are adjusted in a prior learning using a regression method applied to a set of training images comprising images of faces with various poses.

13. The method according to claim 3, wherein parameters of the first geometric transformation and/or of the second geometric transformation are adjusted in a prior learning using a regression method applied to a set of training images comprising images of faces with various poses.

14. The method according to claim 2, wherein the vertical reference line is located at a distance from a center line of the image of between zero and one third of a width of the image.

15. The method according to claim 3, wherein the vertical reference line is located at a distance from a center line of the image of between zero and one third of a width of the image.

16. The method according to claim 4, wherein the vertical reference line is located at a distance from a center line of the image of between zero and one third of a width of the image.

17. The method according to claim 2, wherein a nearest eye is determined based on an estimate of a yaw angle γ or on a comparison of the position of a nose with the position of a line between a midpoint of the mouth and a midpoint between the left eye and the right eye.

18. The method according to claim 3, wherein a nearest eye is determined based on an estimate of the yaw angle γ or on a comparison of the position of a nose with the position of a line between a midpoint of the mouth and a midpoint between the left eye and the right eye.

19. The method according to claim 4, wherein a nearest eye is determined based on an estimate of a yaw angle γ or on a comparison of the position of a nose with the position of a line between a midpoint of the mouth and a midpoint between the left eye and the right eye.

20. The method according to claim 5, wherein a nearest eye is determined based on an estimate of a yaw angle γ or on a comparison of the position of a nose with the position of a line between a midpoint of the mouth and a midpoint between the left eye and the right eye.
